(19) United States
(12) Patent Application Publication
(10) Pub. No.: US 2022/0307425 A1
(43) Pub. Date: Sep. 29, 2022

(54) DUAL MODE PERMANENT MAGNET ELECTRIC MACHINE AND TURNING GEAR SYSTEM FOR AIRCRAFT GAS TURBINE ENGINES

(71) Applicant: BAE Systems Controls Inc., Endicott, NY (US)

(72) Inventors: Matthew S. Boecke, Endicott, NY (US); Laurence D. Vanek, Erie, PA (US)

(21) Appl. No.: 17/287,704

(22) PCT Filed: Mar. 25, 2020
(86) PCT No.: PCT/US20/24598

§ 371 Date: Apr. 22, 2021

(51) Int. Cl. F02C 7/268; F02C 7/26; H02K 3/12

(52) U.S. Cl. CPC F02C 7/268; F02C 7/26; H02K 3/12

(57) ABSTRACT

An electric machine and a turning gear system for aircraft gas turbine engines are provided. The system has an electric machine designed for dual mode operation and a controller. The stator winding arrangement in the electric machine enables operation in either generating mode, during normal flight or motoring mode, during active engine turning. The controller is configured to reconfiguration connections of the windings external to the electric machine.

### FIELD OF THE DISCLOSURE

This disclosure relates to an electric machine having both motoring and generating windings physically separated from each other. This disclosure also relates to turning gear systems for aircraft gas turbine engines using the electric machine.

### BACKGROUND

Modern aircraft gas turbine engines operate at high temperatures that can exceed 1000° C. in parts of the engine during normal flight operations. If the engines are shutdown at airport terminal gates uneven cooling within the engine creates thermal gradients that can result in engine shaft bow that in turn results in excessive vibration if the engines are restarted before all internal parts reach thermal equilibrium.

In order to combat this problem, engine turning gear systems are used which slowly rotates the engine (typically 10 rpm) during combustion shutdown conditions to alleviate the shaft bow problem.

Known turning gear systems have a turning gear motor, a motor controller, a clutch and a gear box to interface with the engine.

Aircrafts also have permanent magnet alternator(s) (PMA) also referred to as a PMG (permanent magnet generator), which is a separate independent power source supplying power to the engine FADEC (full authority digital engine control), a mission critical function. The PMA is typically mounted on a pad on the engine accessory gear box and receives mechanical power from the gear box through a drive shaft.

The PMA provide a regulated DC output voltage to the aircraft FADECs during normal flight operations. During shutdown the PMA may be switched offline when the engine speed coasts down to a preselected engine speed.

### SUMMARY

Disclosed is an electric machine, such as a permanent magnet alternator having separate windings for a generating channel and a motoring channel, e.g., dual mode. The winding configuration for the motoring channel may be reconfigured during operation.

In an aspect of the disclosure, the electric machine may comprise a plurality of generating/motoring channels. This provides redundancy. Each channel, including the redundant channels, is physically separate from each other.

A motoring channel may comprise coils for three-phases. Each phase may comprise at least two coils. Each coil is wound in different slots. The coils are connected in series with the other. Each coil is wound around two different slots.

A generating channel may comprise a coil for three-phases. Each coil is wound in different slots and is wound around two different slots.

In an aspect of the disclosure, the coils for the motoring channel are physically separate from the coils for the generating channel.

Each coil for the generating channel has an output extending from a housing of the dual mode permanent magnet electric machine.

Each phase for the motoring channel has two outputs extending from the housing of the electric machine. One of the outputs is a neutral. This enables the neutrals to be switched external to the electric machine such that the coils may be reconfigured.

For example, in an aspect of the disclosure, a connection configuration for each of the coils of the three-phases for a motoring channel is capable of being switched between a delta configuration and a wye configuration.

In an aspect of the disclosure, the number of coils for each phase for the motoring channel may be based on application of use for the electric machine, such as a use in a turning gear system. For example, in an aspect of the disclosure, three coils may be used for each phase.

Also disclosed is an aircraft gas turbine engine turning gear system. The system may comprise a dual mode permanent magnet electric machine in accordance with aspects of the disclosure and a controller. The controller may be configured to receive an input and configure coils for a three phase motoring channel to a preset connection state when a condition is met to power an engine turbine.

In an aspect of the disclosure, there may be a plurality of three phase motoring channels and the controller may configure the coils for each of the motoring channels to the connection state.

In an aspect of the disclosure, the condition may be a speed. For example, the condition may be the speed of the engine turbine. In other aspects, the speed may be the speed of the rotor or stator of the electric machine.

In an aspect of the disclosure, the system may further comprise a speed sensor to detect the speed of either the engine turbine or the speed of the rotor or stator of the electric machine.

In an aspect of the disclosure, the preset connection state is a wye connection configuration for the coils for the three phase motoring channel.

In an aspect of the disclosure, when the speed is less than a predetermined speed, the controller configures the coils for the three phase motoring channel to a wye connection configuration or maintains the wye connection configuration. Once in the wye connection configuration, the controller is configured to control a driving frequency of the motoring channel to match the speed.

In another aspect of the disclosure, when the speed is greater than the predetermined speed, the controller configures the coils for the three phase motoring channel to a delta connection configuration or maintains the delta connection configuration. Alternatively, in another aspect of the disclosure, when the speed is greater than the predetermined speed, the controller isolates the coils for the three phase motoring channel.

In another aspect of the disclosure, when the speed is greater than the predetermined speed, the controller controls the coils in the generating channel.

In another aspect of the disclosure, the condition is starting an engine from standstill. In accordance with this aspect, the controller may receive a signal from the aircraft, indicative of engine startup. In response to receiving the signal, the controller may configure the coils for the three phase motoring channel to a wye connection configuration or maintain the wye connection configuration. Also, when a speed of the engine turbine or rotor or stator is greater than a predetermined speed, the controller may configure the coils for the three phase motor channel to a delta connection configuration or isolate the coils for the three phase motoring channel.

### BRIEF DESCRIPTION OF THE DRAWINGS

FIG. 1 is a schematic diagram showing the windings for an electric machine in accordance with aspects of the disclosure;

FIG. 2 is a diagram of a turning gear system in accordance with aspects of the disclosure;

FIG. 3 is diagram of another turning gear system in accordance with other aspects of the disclosure;

FIG. 4A is a diagram showing configurable winding configurations for the windings of an electric machine for the motoring channel in accordance with aspects of the disclosure;

FIG. 4B is a diagram showing the positions of switches for the winding configurations shown in FIG. 4A;

FIG. 5 illustrates a flow chart during engine shutdown in accordance with aspects of the disclosure; and

FIG. 6 illustrates a flow chart during engine startup in accordance with aspects of the disclosure.

### DETAILED DESCRIPTION

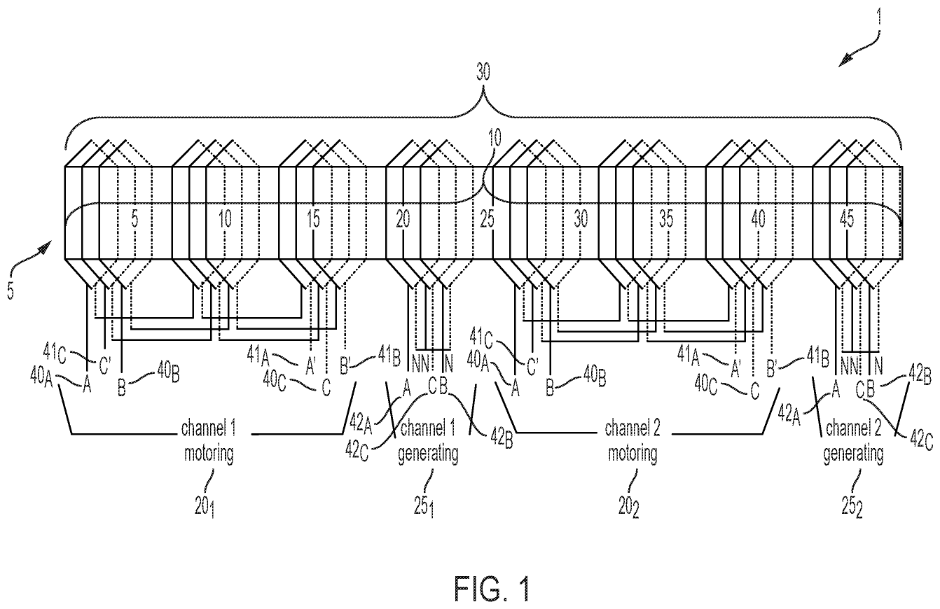

FIG. 1 is a schematic diagram showing the windings for a stator 5 of an electric machine 1 in accordance with aspects of the disclosure. The stator 5 comprises a plurality of slots 10. The slots 10 are spaces for coils to be wound. In the example depicted in FIG. 1, there are 48 slots. However, the number of slots 10 is not limited to 48. In FIG. 1, the slots 10 are identified by numbers. For example, the first slot is slot “1”, the fifth slot is slot “5” where subsequent slots are identified in fives, e.g., 10, 15, 20, 25, 30, 35, 40 and 45.

The electric machine 1 may be a permanent magnet alternator (PMA). The coils 30 are positioned in the slots 10 to create a plurality of independent machines (channels). As depicted, the electric machine 1 has four channels. Two channels are used for motoring: channel 1 motoring 20₁ and channel 2 motoring 20₂. Two channels are used for generating: e.g., channel 1 generating 25₁ and channel 2 generating 25₂. The coils 30 used for each of the channels are physically separated, thus creating the independent operation. The phrase “physically separated” refers to a mechanical gap between the channels where a structure is between them. For example, the channels may be separated by a wall of the slot.

The two motoring channels 20₁ and 20₂ may be used for redundancy. Similarly, the two generating channels 25₁ and 25₂ may be used for redundancy.

The channels, motoring and generating have three phases. The phases are label “A”, “B” and “C” for descriptive purposes. The coil(s) may also be referred to herein as “windings” or “winding”. Coils for the three phases may also be referred to herein as a phase group.

In an aspect of the disclosure, the number of phase groups in a motoring channel 20 and a generating channel 25 may be different. In the example depicted in FIG. 1, there are three phase groups for each motoring channel 20₁ and 20₂ and one phase group for each generating channel 25₁ and 25₂. In accordance with aspects of the disclosure, the motoring channels may be used to turn an engine turbine 260. The number of phase groups per channel are not limited to the example depicted in FIG. 1, and may be application specify. For example, in other aspects, depending on the application, the number of phase groups in a motoring channel 20 and a generating channel 25 may be the same.

Also, the number of phase groups in each motoring channel may not be the same (similar to generating), especially where the channels are not used for redundancy.

In accordance with aspects of the disclosure, the phase groups (and channels) are formed from coils 30 wounds in the slots 10.

A coil 30 is wound around two different slots. For example, a coil is wound around slot 1 and slot 4. The dashed line represents the bottom side of the slot 10 in the machine. Another coil is wound around slot 2 and slot 5 and yet another coil is wound around slot 3 and slot 6. These three coils form a phase group. In this example, the phase group is for the channel 1 motoring 20₁.

In an aspect of the disclosure, the coils 30 are wound as a single layer. However, in other aspects, multiple layers within a slot 10 may be used.

Phase groups in the same channel, e.g., channel 1 motoring 20ₖ, are connected in series. The same phases, e.g., phase A, are connected to each other. The connections may be via a conductive wire 35 coupled to the respective coils. For example, a coil wound in slots 7 and 10 (phase A) may be connected in series with the coil wound in slots 1 and 4. Similarly, the coil would in slots 13 and 16 (also phase A), may be connected in series with the coil wound in slots 7 and 10. The coils for phases B and C are similarly connected in series. Channel 2 motoring 20₂ may have similar connections.

As depicted, the generating channels 25 may only have one phase group and thus no series connections may be needed between multiple groups.

In accordance with aspects of the disclosure, the electric machine 1 may also comprise connecting cables 40/41 for each motoring channel 20. The connecting cables 40/41 extend external to the electric machine 1. The other end of the connecting cables 40/41 may be electrically coupled to the coils 30 (windings). Specifically, connecting cables 40 may be coupled to a coil 30 for a respective phase, e.g., cable 40A may be coupled to a coil 30 for phase A, cable 40B may be coupled to a coil 30 for phase B and cable 40C may be coupled to a coil 30 for phase C. Connecting cables 41 may be coupled to another coil for the respective phase (neutrals), e.g., cable 41A may be coupled to another coil for phase A, cable 41B may be coupled to another coil for phase B and cable 41C may be coupled to another coil for phase C. By have six cables 40A-40C and 41A-41C coming out of the electric machine 1, the configuration of the coils may be externally reconfigured as needed by a controllers 220 or controller 220B. The six cables provide a three-phase output.

The electric machine 1 may also comprise connecting cables 42 for each generating channel 25. In an aspect of the disclosure, one connecting cable 42 is used for each phase. This is because the coils 30 for the three phases are connected to each other, e.g., all of the “neutral” are coupled together. Thus, each generating channel may be configured in a delta configuration internally, whereas, each motoring channel 20 may be configured externally in either a delta or wye configuration.

Connecting cables 42 may be coupled to a coil 30 for a respective phase, e.g., cable 42A may be coupled to a coil 30 for phase A, cable 42B may be coupled to a coil 30 for phase B and cable 42C may be coupled to a coil 30 for phase C. Therefore, three cables 42A-42C come out of the electric machine 1, thus providing a three-phase output.

As depicted in FIG. 1, there may be a total of eighteen cables 40/41/42 coming out of the electric machine 1. Six cables for each of the motoring channels 20 and three cables for each of the generating channels.

In other aspects of the disclosure, the electric machine 1 may comprise a connection terminal block (not shown) and the connecting cables 40/41/42 may be connected to the connection terminal block and a multiple pin cable may be connected to the connection terminal block and extend to the outside of the electric machine 1 instead of multiple separate cables extending outside of the electric machine 1.

In the example depicted in FIG. 1, the electric machine 1 has sixteen poles (not shown); two poles for each phase group (eight phase groups are shown).

In FIG. 1, the rotor and shaft of the electric machine 1 are not shown.

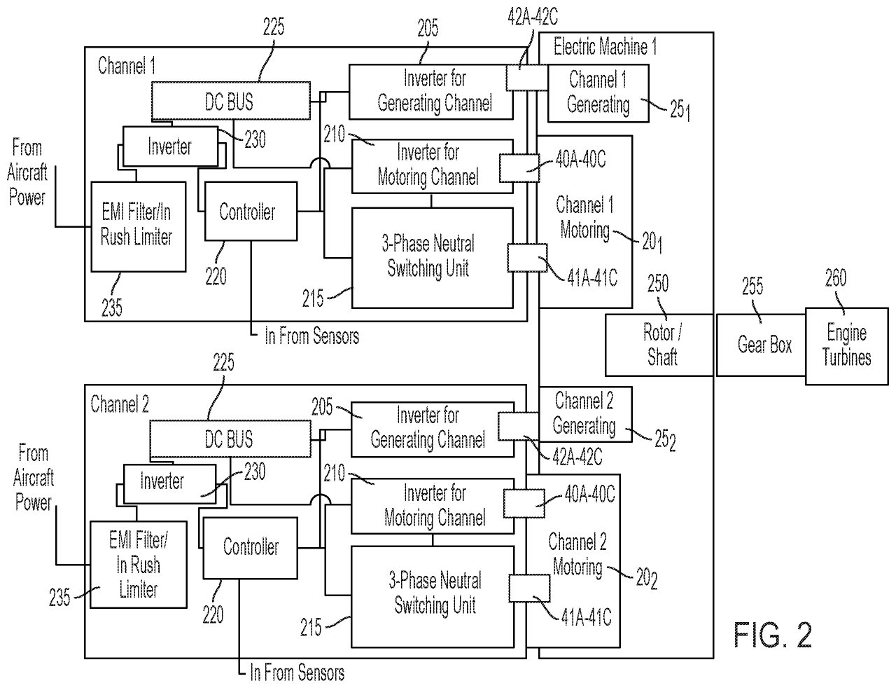

In aspects of the disclosure, the electric machine 1 described above may be used in an engine turning gear system. FIG. 2 illustrates an example of an engine turning gear system with the electric machine 1 in accordance with aspects of the disclosure. The system as depicted in FIG. 2 is incorporated into legacy power control unit (PCU) for a FADEC. Certain components of the legacy PCU have been omitted to highlight the features of the engine turning gear system, however, these features would also be included in the legacy PCU. These features include, but are not limited to, circuitry for producing one or more DC voltages for use by the FADEC, fault and monitoring and overvoltage and overcurrent protection and under voltage and under current detection/protection.

Like the electric machine 1, the system also may have components for two channels, channel 1 and channel 2 (channel 1 may be coupled to channel 1 in the electric machine 1 and channel 2 may be coupled to channel 2 in the electric machine 1). The system may receive power from aircraft and provide power to the FADEC. The power received from the aircraft may be three phase AC. For example, the power may be 115 VAC. Power supplied to the system (and specifically to the PCU identified in the figures as Channel 1 and Channel 2), is filtered by an EMI Filter/In rush Limiter 235 (in each channel). The inrush limiter may comprise a resistor for each phase. For example, the resistor may be a Negative temperature coefficient (NTC) thermistor. In other aspects, the resistor may have a fixed value.

The components of channel 1 and channel 2 are the same. Therefore, the description will refer to the components without specifying “channel 1” or “channel 2” after except where necessary.

The received power may be converted to DC for a DC bus 225 using a three-phase inverter 230 under the control of controller 220. The DC bus 225 may have a specific value. For example, the DC bus 225 may be 270 VDC. In other aspects of the disclosure, the voltage of the DC bus 225 may be higher. The three-phase inverter 230 may act as a boost converter increasing the input voltage to obtain the DC bus voltage.

The system may further comprise additional inverters, one inverter used for the generating channel 205 and another inverter for the motoring channel 210 (per channel). In an aspect of the disclosure, the inverters 205/210 are also three-phase inverters. The inverters 205/210 are electrically coupled to the DC bus 225. Inverter 205 may be coupled to the generating channel 25 via cables 42A-42C and inverter 210 may be coupled to the motoring channel 20 via cables 40A-40C.

The system may further comprise a 3-phase neutral switching unit 215 (per channel). The 3-phase neutral switching unit 215 may be coupled to the motoring channel 20 via cables 41A-41C.

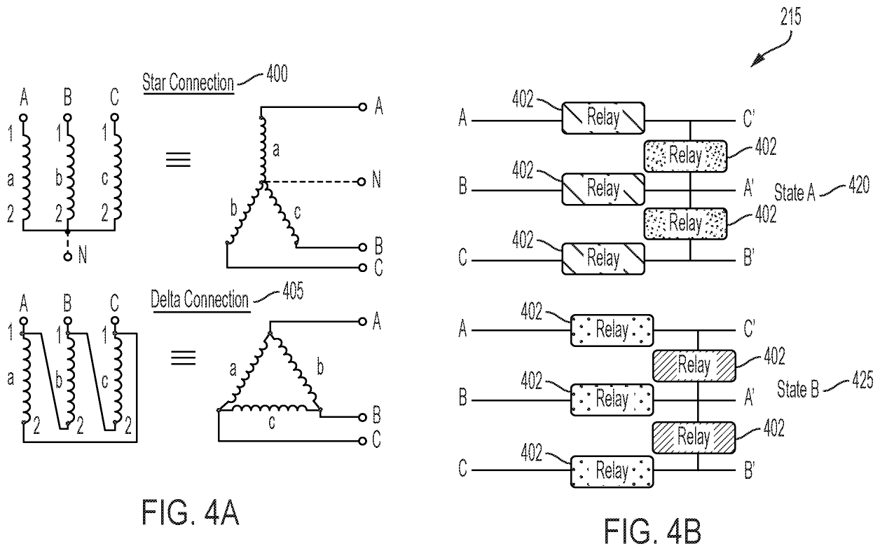

In accordance with aspects of the disclosure, the 3-phase neutral switching unit 215 may be configured to reconfigured the neutrals for the motoring channel 20 such that the windings for the motoring channel has either a delta configuration 405 or a wye (star) configuration 400 (see FIG. 4A). This reconfiguration is external to the electric machine 1.

An example of the 3-phase neutral switching unit 215 is shown in FIG. 4B. The 3-phase neutral switching unit 215 may comprise a plurality of relays 402. The relays 402 open and close to change connections. In other aspects of the disclosure, other types of switches may be used, such as MOSFETS.

In the example depicted in FIG. 4B, there are five relays 402. Two relays 402 between the respective neutrals of the phases, e.g., one relay 402 between A′ and B′ and another relay 402 between A′ and C′. Three relays 402 are between the phases and the neutrals. For example, a relay 402 is between phase A and neutral C′, another relay 402 is between phase B and neutral A′ and another relay 402 is between C and neutral B′.

The system may also comprise a controller 220 (per channel). In an aspect of the disclosure, each controller 220 may be a field programmable gate array (FPGA) configured to execute the functionality described herein. In other aspects of the disclosure, the controller 220 may be an ASIC or a CPU. For example, the CPU may include a processor and memory. The memory may include a program of instructions for executing the functionality described herein and predetermined thresholds, predetermined steady state turning gear speed, frequencies, voltages, etc.

In accordance with aspects of the disclosure, the controllers 220 are configured to control the relays 402 in the 3-phase neutral switching units 215 in order to configure the windings of the motoring channels to either a delta configuration 405 or a wye (star) configuration 400. For example, each controller 220 may control the relays 402 to configure the windings for a wye configuration 400 when in a motoring mode, e.g., when the system is activating turning the engine turbines 260. Each controller 220 may control the relays 402 to configure the windings for a delta configuration 405 in a normal flying mode, e.g., when not activating turning the engine turbines 260.

The controllers 220 are also configured to control the inverters 205 in a generating mode and inverters 210 in the motoring mode. When in the motoring mode, each controller 220 may control the inverters 210 at a specific frequency to supply a specific VAC to the electric machine 1 to match the speed of the engine turbines 260 and decelerate the turbines to a predetermined steady state turning gear speed at a controllable deceleration rate or start the engine turbine up to the threshold.

In aspects of the disclosure, the controllers 220 may receive information from aircraft sensors (not shown) or an aircraft controller. For example, the aircraft sensors may be speed sensors for sensing or detecting the speed of the engine turbines 260. The received speed may be used to determine when to activate the motoring mode, e.g., turn the engine turbines 260, using the motoring channels 20 of the electric machine 1. In other aspects of the disclosure, the system may include an internal speed sensor for sensing the speed of the engine turbines 260. In yet other aspects, the speed sensor may sense the rotation of the rotor/shaft 250 of the electric machine 1 instead of the speed of the engine turbines 260. In other aspects, the control may be without a sensor, e.g., sensorless, such as by using a back EMF of the electric machine.

The aircraft controller may send a signal indicating an engine start. In other aspects, the controllers 220 may receive a KEY ON signal responsive to the operator turning the aircraft on.

The controller 220 in each channel controls the respective inverters 205/210 and the 3-phase neutral switching unit 215 in synchronization. In an aspect of the disclosure, the controller 220 in each channel communicates with the other channel controller to synchronize the output.

The engine turbines 260 are mechanically coupled to the rotor/shaft 250 via a gear box 255.

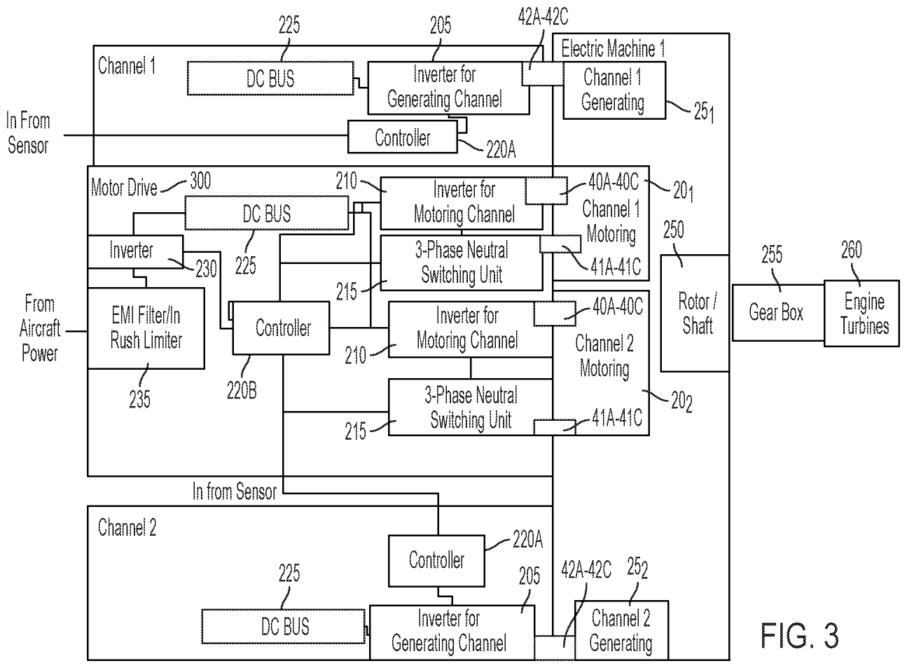

FIG. 3 illustrates another example of the system. A difference between the system in FIG. 3 and the system in FIG. 2 is the system in FIG. 3 has a motor drive 300 separate from the generating channels. For example, a separate controller(s) is used for the motoring channels 20 and the generating channels 25. The motor drive 300 may include controller 220B. As depicted in the example in FIG. 3, one controller 220B is used. However, in other aspects, two controllers may be used, one for channel 1 motoring 20₁ and another for channel 2 motoring 20₂.

Like with controller 220, controller 220B controls the inverters for the motoring channel 210 and the 3-phase neutral switching unit 215. The controller 220B controls the inverter 210 for channel 1 motoring in synchronization with the inverter 210 for channel 2 motoring. In an aspect of the disclosure, the components may communicate with the components of the other channel(s) to synchronize.

The motor drive 300 may receive power from the aircraft. This power is filtered (by the EMI filter) and subject to an inrush current limiter. The power is then converted from AC to DC by the inverter 230 under the control of controller 220B. The DC bus 225 may have a specific value. For example, the DC bus 225 may be 270 VDC. In other aspects of the disclosure, the voltage of the DC bus may be higher.

The voltage of the DC bus 225 is the same for the motor drive 300, channel 1 (generating) and channel 2 (generating). In an aspect of the disclosure, the controller 220B may be a field programmable gate array (FPGA) configured to execute the functionality described herein. In other aspects of the disclosure, the controller 220B may be an ASIC or a CPU. For example, the CPU may include a processor and memory. The memory may include a program of instructions for executing the functionality described herein and predetermined thresholds, predetermined steady state turning gear speed, frequencies, voltages, etc.

In accordance with aspects of the disclosure, the controller 220B is configured to control the relays 402 in both 3-phase neutral switching units 215 in order to configure the windings of the motoring channels to either a delta configuration 405 or a wye (star) configuration 400, in synchronization

The controller 220B may also receive the same sensor information as described above and control the relays 402 in both 3-phase neutral switching units 215 based thereon.

Channel 1 may include controller 220A. Controller 220A controls the inverter for the generating channel 205. Similarly, channel 2 may include controller 220A. The controllers in channel 1 and channel 2 function the same way. Additionally, the controllers 220A control the respective inverters 205 in synchronization.

The turning gear systems as described in FIGS. 2 and 3 may be used for both applying breaking torque to arrest the engine turbines deceleration during coast down after combustion shutdown and bring it to a predetermined steady state turning gear speed and to start an engine from standstill and bring it to a threshold speed. For example, the predetermined steady state turning gear speed may be 10 rpm. In other aspects, the steady state turning gear speed may be 20 rpm. The specific steady state turning gear speed may be different depending on the type of aircraft and/or the type of engine.

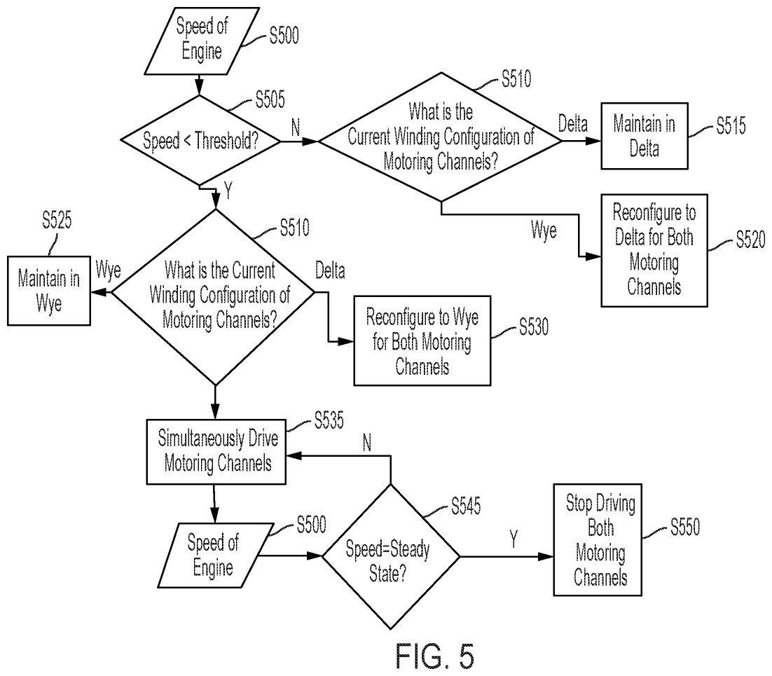

FIG. 5 illustrates features for determining when to engage the motoring mode during engine shutdown and executing the motoring mode in accordance with aspects of the disclosure. The following description describes the functionality of the controllers in both FIG. 2 and FIG. 3 as alternate systems (“or”).

The controllers 220 (in an example system as depicted in FIG. 2) or controller 220B and controllers 220A (in an example system as depicted in FIG. 3) may receive speed information (S500). As described above, the speed information may be the speed of the engine turbine 260. The speed information may be detected by a speed sensor, such as an RPM sensor. This sensor may be one of the sensors in the legacy FADEC system. In other aspects, a dedicated sensor for the turning gear system may be used. In other aspects, instead of or in addition to the speed of the engine turbine, the controllers 220 (in an example system as depicted in FIG. 2) or controller 220B and controllers 220A (in an example system as depicted in FIG. 3) may receive the speed information of the rotor/shaft 250.

At S505, the controllers 220 or controller 220B and controller 220A may determine whether the speed is less than a speed threshold. When the speed is less than the threshold, it is indicative of a combustion shutdown event and that the motoring mode should be activated. In other aspects of the disclosure, instead of using the speed, the controllers 220 or controller 220B and controllers 220A may receive a signal from the FADEC indicating the combustion shutdown event.

In response to a determination that the speed is less than the threshold (“Y” at S505), the controllers 220 or controller 220B may determine the current winding configurations for the motoring channels 20, what is the external configuration of the windings. In an aspect of the disclosure, the controllers 220 or controller 220B determines the state of the relays 402 in the 3-phase neutral switching unit 215. Since the control is synchronized, each 3-phase neutral switching unit 215 should have the same state. For example, when the relays 402 are in State A 420 as shown in FIG. 4B, the windings are in a star or wye configuration 400. When the relays 402 are in State B 425 as shown in FIG. 4B, the windings are in a delta configuration 405.

When the windings are already externally configured (external to the electric machine 1) to a wye configuration 400 (a “Wye” determination at S510), the controllers 220 or controller 220B may maintain the winding configuration at S525. When the windings are in the delta configuration 405 (a “delta” determination at S510), the controllers 220 or controller 220B may reconfigure the windings for a wye configuration 400. The wye configuration 400 allows for higher motoring torque at low speed to meet the engine turning requirements (than a delta configuration 405).

The controllers 220 or controller 220B simultaneously control the relays 402 in both 3-phase neutral switching units 215. For example, the controllers 220 or controller 220B change the state of the relays from State B 425 shown in FIG. 4B to State A 420 shown in FIG. 4A at S530.

In some aspects, the controllers 220 may also stop commanding the inverters for the generating channels 205 to generate power for the DC bus 225. In other aspects of the disclosure, the inverters for the generating channels 205 may be electrically isolated from either the DC bus 225 or the electric machine 1.

Similarly, when an example system as shown in FIG. 3 is used, each controller 220A (which also receive the speed), may also stop commanding the respective inverter for the generating channel 205 to generate the power for the DC bus 225. The two channels are controlled in synchronization. In other aspects of the disclosure, the respective inverters for the generating channels 205 may be electrically isolated from either the DC bus 225 or the electric machine 1.

Once the winding configuration is the wye configuration 400, the controllers 220 (in an example system as depicted in FIG. 2) or controller 220B (in an example system as depicted in FIG. 3) may determine the drive frequency and voltages to apply to the electric machine 1 at S535. For example, the controllers 200 or controller 220B may determine the frequency and voltages required to initially match the speed of the engine and subsequently applying a braking torque and reduce the engine deceleration rate. The specific frequency and voltages required may be based on the threshold speed, the target deceleration rate and the predetermined steady state turning gear speed. In some aspects of the disclosure, an initial frequency and voltages may be preset into the controllers for a specific aircraft. For example, the initial frequency and voltages may be programmed into the controllers 220 or controller 220B during configuration and testing. The same frequency and voltages are used for both channels.

Once the frequency and voltages are determined, the controllers 220 or controllers 220B simultaneously control the inverters 210 also at S535. The combined torque produced by channel 1 motoring 20₁ and channel 2 motoring 20₂ in the electric machine 1 decelerates the engine turbine 260 to the predetermined steady state turning gear speed.

The controllers 220 (in an example system as depicted in FIG. 2) or controller 220B and controllers 220A (in an example system as depicted in FIG. 3) may continuously receive speed information (S500). As described above, the speed information may be the speed of the engine turbine 260 or the rotor/shaft 250.

At S545, the controllers 220 or controller 220B may determine whether the speed is the predetermined steady state turning gear speed. When the speed reaches the predetermined steady state turning gear speed (“Y” at S545), the controllers 220 or controller 220B stop driving both motoring channels 20 at S550. Specifically, the controllers 220 or controller 220B stop commanding a voltage and frequency from each of the inverters 210.

The controllers 220 or controllers 220A may maintain the generating channels 25 in an offline state since the speed is still less than the threshold.

When the speed has not reached the predetermined steady state turning gear speed (“N” at S545, the controllers 220 or controller 220B may continue to drive the motoring channels 20. However, the controllers 220 or controller 220B may adjust the frequency and voltages commanded from the respective inverters 210 based on the current speed.

When at S505, it is determined that the speed is greater than or equal to the threshold (“N” at S505), the controllers 220 or controller 220B may determine the current winding configurations for the motoring channels 20 at S510. Here, when the windings are already externally configured (external to the electric machine 1) in the delta configuration 405, the controllers 220 or controller 220B maintain the winding configuration at S515 (a determination of “delta” at S510).

When the winding configuration is in a wye configuration (a determination of “wye” at S510), the controllers 220 or controller 220B reconfigures the windings for a delta configuration 405 at S520. The controllers 220 or controller 220B simultaneously control the relays 402 in both 3-phase neutral switching units 215. For example, the controllers 220 or controller 220B change the state of the relays 402 from State A 420 shown in FIG. 4A to State B 425 shown in FIG. 4B at S520. A delta configuration allows for lower voltage at a high speed to help mitigate corona and partial discharge in the machine windings. The delta configuration also limits a peak voltage to the ground induced in the winding groups. This is because motoring is not required.

In another aspect of the disclosure, instead of reconfiguring the windings for the motoring channels 20, the system may include switches which electrically isolate the windings. For example, the switches would disconnect the windings at each end from the respective inverter 210 to limit the peak voltage to ground.

Advantageously, by controlling the winding configuration (outside of the electric machine 1) for the motoring channels 20 in an electric machine 1, the same electric machine 1 may provide high torque at low speed operation as well as low voltage induced at high speeds.

The controllers 220 or controllers 220A operate the generating channels 25 in an “online” state and command the respective inverter 205 for the channels to generate the power for the DC bus 225. The power may be available for the engine FADEC.

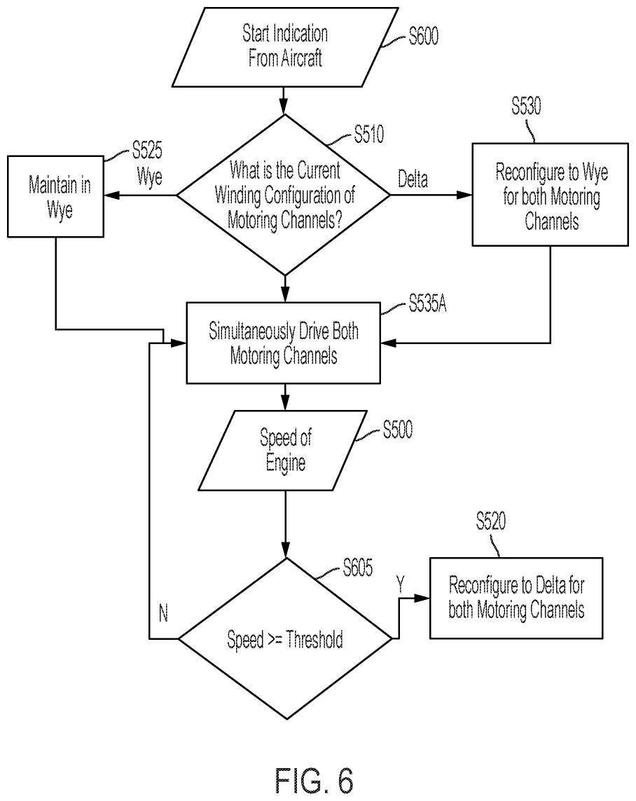

FIG. 6 illustrates features for determining when to engage the motoring mode for engine startup and executing the motoring mode in accordance with aspects of the disclosure.

At S600, the controllers 220 (in an example system as depicted in FIG. 2) or controller 220B and controllers 220A (in an example system as depicted in FIG. 3) may receive a start indication from the aircraft.

In response to the receipt of the indication, the controllers 220 or controller 220B determines the current configuration of the windings at S510 (connection configuration, such as wye configuration or a delta configuration). When the winding configuration is already externally configured (external to the electric machine 1) in the wye configuration 400, the controllers 220 or controller 220B maintain the configuration. However, when the winding configuration is in a delta configuration (a determination of “delta” at S510), the controllers 220 or controller 220B reconfigure the windings for a wye configuration 400. The wye configuration 400 allows for higher motoring torque at low speed to meet the engine turning requirements (than a delta configuration).

The controllers 220 or controller 220B may simultaneously control the relays 402 in both 3-phase neutral switching units 215. For example, the controllers 220 or controller 220B change the state of the relays from State B 425 shown in FIG. 4B to the State A 420 shown in FIG. 4A at S530.

Once the winding configuration is the wye configuration 400, the controllers 220 (in an example system as depicted in FIG. 2) or controller 220B (in an example system as depicted in FIG. 3) may determine the drive frequency and voltages for applying to the electric machine 1 at S535A to start the engine turbines 260 to a threshold speed. For example, the controllers 220 or controller 220B may determine the frequency and voltages required accelerate the turbine 260 to the threshold speed, e.g., required torque. The specific frequency and voltages required may be based on a target acceleration rate, and the threshold speed. In some aspects of the disclosure, an initial frequency and voltages may be preset into the controllers for a specific aircraft. For example, the initial frequency and voltages may be programmed into the controllers 220 or controller 220B during configuration and testing. The same frequency and voltages are used for both channels.

Once the frequency and voltages are determined, the controllers 220 or controllers 220B may simultaneously control the inverters 210 also at S535A. The combined torque produced by channel 1 motoring 20₁ and channel 2 motoring 20₂ in the electric machine 1 accelerates the engine turbine 260 to the threshold speed.

In response to the receipt of the indication, the controllers 220 or controllers 220A will control the generating channels 25 to be offline until the speed is greater than or equal to the threshold.

The controllers 220 (in an example system as depicted in FIG. 2) or controller 220B and controllers 220A (in an example system as depicted in FIG. 3) may continuously receive speed information (S500). As described above, the speed information may be the speed of the engine turbine or the rotor/shaft.

At S605, the controllers 220 or controller 220B may determine whether the speed is equal to or greater than the threshold. When the speed reaches the threshold (“Y” at S605), the controllers 220 or controller 220B may stop driving both motoring channels 20. Specifically, the controllers 220 or controller 220B stop commanding a voltage and frequency from each of the inverters 210. Additionally, the controllers 220 or controller 220B may reconfigure the winding configuration from a wye configuration 400 to a delta configuration 405 at S520. The controllers 220 or controller 220B simultaneously control the relays 402 in both 3-phase neutral switching units 215. For example, the controllers 220 or controller 220B change the state of the relays 402 from State A shown in FIG. 4A to State B shown in FIG. 4B at S520. A delta configuration 405 allows for lower voltage at a high speed to help mitigate corona and partial discharge in the machine windings. The delta configuration 405 also limits a peak voltage to the ground induced in the winding groups. Motoring mode is no longer needed.

In other aspects of the disclosure, instead of reconfiguring the winding configuration, the system may include switches which electrically isolate the windings. For example, the switches would disconnect the windings at each end from the respective inverter 210 to limit the peak voltage to ground.

Additionally, when the speed reaches the threshold, the controllers 220 or controllers 220A place the generating channels 25 in an online state. For example, the controllers 220 or controllers 220A control the inverters 205 to supply power to the DC bus 225 using the electric machine 1.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

What is claimed is:

1. An aircraft gas turbine engine turning gear system comprising:
a dual mode permanent magnet electric machine having coils for a three phase motoring channel and coils for a three phase generating channel; and
a controller configured to receive input and configure the coils for the three phase motoring channel to a preset connection state when a condition is met to power an engine turbine.

2. The aircraft gas turbine engine turning gear system of claim 1, wherein the preset connection state is a wye connection configuration for the coils for the three phase motoring channel.

3. The aircraft gas turbine engine turning gear system of claim 1, wherein the condition is a speed.

4. The aircraft gas turbine engine turning gear system of claim 3, wherein when the speed is less than a predetermined speed, the controller configures the coils for the three phase motoring channel to a wye connection configuration or maintains the wye connection configuration.

5. The aircraft gas turbine engine turning gear system of claim 4, wherein the controller is configured to control a driving frequency of the motoring channel to match the speed after configuring the coils for the three phase motoring channel to the wye connection configuration or maintaining the wye connection configuration.

6. The aircraft gas turbine engine turning gear system of claim 4, wherein when the speed is greater than the predetermined speed, the controller configures the coils for the three phase motoring channel to a delta connection configuration or maintains the delta connection configuration.

7. The aircraft gas turbine engine turning gear system of claim 4, wherein when the speed is greater than the predetermined speed, the controller isolates the coils for the three phase motoring channel.

8. The aircraft gas turbine engine turning gear system of claim 4, wherein when the speed is greater than the predetermined speed, the controller controls the coils in the generating channel.

9. The aircraft gas turbine engine turning gear system of claim 1, wherein the condition is starting an engine from standstill.

10. The aircraft gas turbine engine turning gear system of claim 9, wherein the controller receives a signal from the aircraft, and wherein when the signal is received, the controller configures the coils for the three phase motoring channel to a wye connection configuration or maintains the wye connection configuration.

11. The aircraft gas turbine engine turning gear system of claim 3, further comprising a speed sensor configured to detect a speed, wherein when the detected speed is greater than a predetermined speed, the controller configures the coils for the three phase motor channel to a delta connection configuration or isolates the coils for the three phase motoring channel.

12. The aircraft gas turbine engine turning gear system of claim 3, further comprising a speed sensor configured to detect a speed, and wherein when the speed is less than a predetermined speed, the controller configures the coils for the three phase motoring channel to a wye connection configuration or maintains the wye connection configuration.

13. The aircraft gas turbine engine turning gear system of claim 1, wherein a dual mode permanent magnet electric machine comprises a plurality of three phase motoring channels and a plurality of three phase generating channels.

14. A dual mode permanent magnet electric machine comprising:
a plurality of slots;
at least one motoring channel and generating channel,
each motoring channel comprises:
coils for three-phases, where each phase has at least two series connected coils, each of the at least two coils being wound in different slots where each coil is wound around two different slots;
each generating channel comprises:
a coil for three-phases, each coil being wound in different slots where each coil is wound around two different slots,
the coils for the motoring channel being physically separated from the coils for the generating channel; and
wherein each of three-phases for the motoring channel has two outputs extending from the dual mode permanent magnet electric machine, one of the two outputs being a neutral; and
wherein each coil for the generating channel has an output extending from the dual mode permanent magnet electric machine.

15. The dual mode permanent magnet electric machine of claim 14, wherein a connection configuration for coils of the three-phases for the motoring channel is capable of being switched.

16. The dual mode permanent magnet electric machine of claim 15, wherein coils of the three-phases for the motoring channel are capable of having a delta configuration and a wye configuration.

17. The dual mode permanent magnet electric machine of claim 14, wherein for the motoring channel each of the three-phases has three coils.

18. The dual mode permanent magnet electric machine of claim 14, wherein the at least one motoring channel and generating channel comprising a plurality of motoring channels and a plurality of generating channels.

19. The dual mode permanent magnet electric machine of claim 18, wherein the motoring channels and generating channels are physically separated from each other.

20. The dual mode permanent magnet electric machine of claim 14, further comprising a terminal block, wherein the same terminal block is used for all of the motoring channels and the generating channels.
